(19) United States
(12) Patent Application Publication
(10) Pub. No.: US 2026/0001066 A1
(43) Pub. Date: Jan. 1, 2026

(54) NiCu/La-ZEOLITE CATALYST

(71) Applicant: Khalifa University of Science and Technology, Abu Dhabi (AE)

(72) Inventors: Kyriaki POLYCHRONOPOULOU, Abu Dhabi (AE); Mariam Ahmed MOHAMMED, Abu Dhabi (AE); Sara Ishaq ALKHOORI, Abu Dhabi (AE)

(21) Appl. No.: 19/255,006

(22) Filed: Jun. 30, 2025

Related U.S. Application Data
(60) Provisional application No. 63/666,420, filed on Jul. 1, 2024.

(51) Int. Cl. B01J 29/78; B01J 35/40; B01J 35/61; B01J 35/77; B01J 37/02; C10G 3/00

(52) U.S. Cl. CPC B01J 29/7815; B01J 35/40; B01J 35/615; B01J 35/77; B01J 37/0205; C10G 3/49; B01J 2235/15; C10G 2300/1011; C10G 2300/70; C10G 2400/04

(57) ABSTRACT

A method of manufacturing a catalyst includes mechanochemically processing an input material to generate a processed material, where the input material comprises a support and loading the processed material with a loading material. The support is a zeolite, a Beta zeolite, or a H-Beta zeolite and the loading material comprises nickel (Ni) or nickel-copper (NiCu). Lanthanum oxide (La₂O₃) is a promoter for the catalyst. A first interface of a NiCu/La-zeolite catalyst is generated when the loading material further includes the promoter; and a second interface of a NiCu/La-zeolite catalyst is generated when the input material further includes the promoter.

### CROSS-REFERENCE TO RELATED APPLICATIONS

This application claims the benefit of and priority to U.S. provisional application 63/666,420, titled “NiCu/La-zeolite catalyst for biofuel upgrading through hydrodeoxygenation reaction”, filed Jul. 1, 2024, the contents of which are incorporated by reference herein.

### TECHNICAL FIELD

The subject matter disclosed herein relates to the production of catalysts and, in particular, to the production of catalysts configured for hydrodeoxygenation reactions to produce biofuel.

### BACKGROUND

Fossil fuel reserves are depleting while global demand for fuel is increasing. There is a rise in the level of concern regarding harmful emissions and the carbon footprint with a projected enhancement of carbon emission level by 80% from 2007 to 2030. A step towards lessening the reliance on fossil fuels is to replace petroleum-derived fuels with green biofuels which have proved to be biodegradable, non-toxic, and environmentally friendly. Green biofuels such as green diesel play an important role in the clean energy transition specifically in decarbonizing transport by supplying a low-carbon solution for transportation industries which are considered hard to abate. To generate biofuel, biomass feedstocks undergo a deoxygenation reaction which consists of three pathways: decarboxylation (DCO₂), decarbonylation (DCO), and hydrodeoxygenation (HDO). DCO and DCO₂ both reduce the carbon number from the hydrocarbon yield due to the C—C bond cleavage and generate pollutants as byproducts (CO and CO₂). In contrast, according to the atom economy, HDO conserves the carbon number and is environmentally friendly.

### SUMMARY

According to one aspect, a method of manufacturing a catalyst includes mechanochemically processing an input material to generate a processed material, loading the processed material with a loading material. The input material includes a support, wherein the support is a zeolite, a Beta zeolite, or a H-Beta zeolite. The loading material includes nickel (Ni) or nickel-copper (NiCu). Lanthanum oxide (La₂O₃) is a promoter for the catalyst. A first interface of a NiCu/La-zeolite catalyst is generated when the loading material further includes the promoter and a second interface of a NiCu/La-zeolite catalyst is generated when the input material further includes the promoter.

According to another aspect, a 10Ni5Cu/10La₂O₃/H-Beta catalyst characterized by one or more of: a crystallite size (D_{Beta}) of about 13-11 nm; an average metal particle size (d_{M}) of about 4-5 nm; a metal (Ni+NiCu) dispersion (D_{M}) of about 21-25%; a Ni crystallite size (D_{Ni}) of about 14-16 nm; a total surface area of about 400-450 m²/g; a total basic site of about 0.120-0.225 mmol/g; and a total acid site of about 1-1.2 mmol/g.

According to a further aspect, a method includes mixing an activated mechanochemically processed NiCu/La-zeolite catalyst with biomass; conducting a hydrogenation reaction (HDO) of the biomass; and separating diesel range products from a mixture generated by the hydrogenation reaction.

### BRIEF DESCRIPTION OF THE DRAWINGS

FIG. 1 is a block diagram of a system that may be utilized to generate a catalyst according to some embodiments. Solid lined boxes indicate components of the system and dashed lined boxes indicate input/outputs of the system.

FIG. 2 is a flowchart of a method to generate a catalyst according to some embodiments.

FIG. 3 is a flowchart of a method to generate a catalyst according to some embodiments.

FIGS. 4A-D illustrate results of assessments of a catalyst according to some embodiments. FIG. 4A is a graph 400 of X-ray diffraction (XRD patterns of 10Ni5Cu/10La₂O₃/H-Beta generated without mechanochemical processing; 10Ni5Cu/10La₂O₃/H-Beta_IF1, and 10Ni5Cu/10La₂O₃/H-Beta_IF2. FIG. 4B is an image 410 of Red-Green-Blue (RGB) mapping analysis of 10Ni5Cu/10La₂O₃/H-Beta_IF1 FIG. 4C is a graph 420 illustrating the results of H₂ temperature-programmed reduction (H₂-TPR) studies. FIG. 4D is a graph 430 illustrating the results of H₂ temperature-programmed desorption (H₂-TPD) experiments performed to assess the hydrogen chemisorption onto the surface exposed metal.

FIGS. 5A-B illustrate results of assessments of a catalyst according to some embodiments. FIG. 5A provides a graph 500 of linear combination fitting (LCF) of the XANES spectra at the Ni K-edge (8333 eV), recorded for the 10Ni/10La-H-Beta (MAM 1-36), 10Ni5Cu/10La-H-Beta (MAM 1-37), and 10Ni5Cu/10La-H-Beta IF1 (MAM 1-44) catalysts. In comparison to the Ni foil reference, the results indicate that Ni is present in the metallic state across all catalysts. FIG. 5B provides a graph 510 of an Extended XAFS Fourier Transform fitting of both the magnitude and real part for these samples.

FIGS. 6A-B illustrate results of assessments of a catalyst according to some embodiments. FIG. 6A is a graph 600 illustrating the results of X-ray absorption near edge structure (XANES) analysis at the Cu K-edge conducted to investigate the oxidation state of copper in the catalysts FIG. 6B is a graph 610 illustrating the results of extended X-ray absorption fine structure (EXAFS) analysis

FIGS. 7A-C illustrate results of HDO experiments conducted to evaluate the following catalysts: 10Ni/H-Beta (no mechanochemical treatment), 10Ni/10La-H-Beta (no mechanochemical treatment), 10Ni5Cu/10La-H-Beta (no mechanochemical treatment), 10Ni5Cu/10La-H-Beta (IF1), and 10Ni5Cu/10La-H-Beta (IF2). FIG. 7A is a graph 700 illustrating the alkane carbon number distribution. FIG. 7B provides a graph 710 illustrating the effect of time, 1 h, 2 h, and 3 h, on 10Ni5Cu/10La-H-Beta (IF2). FIG. 7C provides a graph 720 illustrating the effect of pressure (30 bar, 50 bar, and 65 bar) on 10Ni5Cu/10La-H-Beta (IF2) at a constant reaction time of 1 h.

### DETAILED DESCRIPTION

Because deoxygenation reactions are complex, designing an effective bifunctional catalyst that does not produce pollutants as byproducts and may be utilized in the selective production hydrocarbon fuels. The present disclosure describes a system and methods to produce a catalyst that may be utilized to produce diesel range products (C₁₅-C₁₂) via a hydrodeoxygenation (HDO) reaction. Production of the catalyst includes a mechanochemical treatment of the support. The methods disclosed herein to produce the catalyst are economical, environmentally safe, and utilize easy to operate devices. In at least one embodiment, the catalyst is a NiCu/La-zeolite catalyst. In some embodiments, the NiCu/La-zeolite catalyst is a mechanochemically treated catalyst. The NiCu/La-zeolite catalyst is a bimetallic catalyst where zeolite is the support, lanthanum (La) is the promoter, and nickel-copper (Ni-Cu) form the active sites of the catalyst. Manufacturing a NiCu/La-zeolite catalyst as disclosed herein is low-cost because transition metals, nickel and copper, are utilized. These metals are more abundant and less expensive than noble metals such as platinum (Pt), palladium (Pd), and Ruthenium (Ru). Additionally, the NiCu/La-zeolite catalyst is a non-sulfide-based catalyst. Some drawbacks of sulfide based catalysts include deactivation of the catalyst. For example, sulfur leaching in the presence of water (reaction product) results in coking which blocks active sites of the catalysts. As another example, phenate formation may also occur which has been found to decrease the accessibility of sulfidated sites. Additional hydrocarbons generated with a sulfide based catalyst may be contaminated with sulfur compounds which require additional processing to remove, thereby increasing production costs.

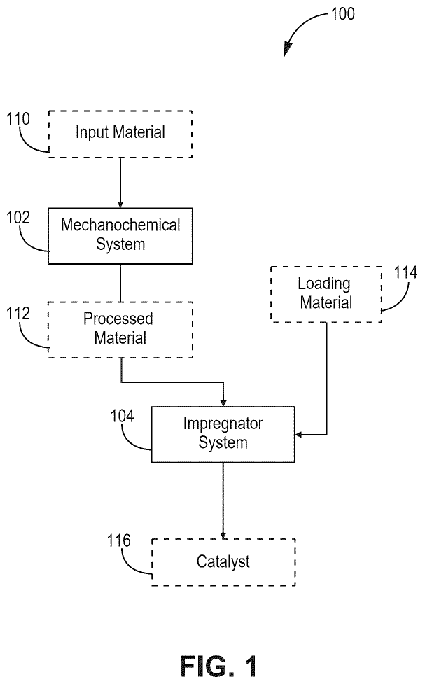

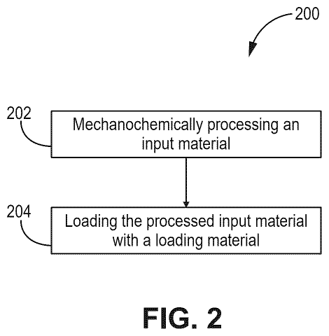

FIG. 1 is a block diagram of a system 100 that may be utilized produce a catalyst. In at least one embodiment, system 100 is utilized to produce a NiCu/La-zeolite catalyst. Solid lined boxes indicate components of the system and dashed lined boxes indicate input/output materials for the system 100, which are discussed in more detail with reference to methods for producing the catalyst (see FIG. 2). The system 100 includes a mechanochemical system 102 and an impregnator system 104.

The mechanochemical system 102 is configured to receive an input material 110 and output a processed material 112. In at least one embodiment the mechanochemical system 102 is a milling device. In some embodiments, the milling device is a planetary ball mill. In other embodiments, the milling device is a wet media mill.

The impregnator system 104 is configured to receive the milled material 112 and a loading material 114 and to output the catalyst 116. In at least one embodiment, the impregnator device is configured to assist in the impregnating (loading) the loading material onto the support. The impregnation device 104 may be configured for a classical wet impregnation method where the solution of active metal is being impregnated onto the aqueous dispersion of the support.

FIG. 2 is a flowchart of a method 200 to generate a catalyst. Method 200 may utilize system 100 to manufacture a catalyst. As discussed below in greater detail, the catalyst includes a support, a promoter, and one or more metals. In at least one embodiment, the method 200 may be utilized to generate catalysts with different interfaces due to a difference in the sequence of mechanical processing of the material.

Turning to method 200 detailed in the flowchart of FIG. 2, at Step 202, an input material is mechanochemically processed. As used herein mechanochemical processing utilizes physical forces to increase surface area, increase defects, alter crystal structure and interfaces or induce amorphization, to mechanically incorporate promoters and/or to synthesize new catalyst phases (e.g., mixed metal oxides, alloys, doped materials). In at least one embodiment, the input material includes the support. In at least one embodiment, the support is a zeolite. The zeolite may be a powder. In some embodiments, the zeolite is a beta form of the zeolite. In one non-limiting example, the zeolite beta form is H-beta, a protonic (acidic) form of Beta zeolite. In at least one embodiment, the zeolite support has a SiO₂/Al₂O₃ mole ratio of 25 and surface area of 680 m₂/g. A benefit of H-beta is that it has strong Brønsted acidity which may be useful for HDO

In other embodiments, the input material includes the support and the promoter. In at least one embodiment, the promoter is lanthanum oxide (La₂O₃). In some embodiments, the promoter is in an aqueous solution. For example, the aqueous solution of the La₂O₃ promoter may be an aqueous solution of La(NO₃)₃ (e.g., La(NO₃)₃·6H₂O). The amount of La(NO₃)₃·6H₂O solution may be sufficient to produce a catalyst comprising 10La₂O₃ (10 wt % La₂O₃). Deionized (DI) water may be utilized to make an aqueous solution disclosed herein.

The mechanochemical processing of Step 202 may decrease the crystallite size of the support and increase in the exterior surface area of the support. For example, when the support is porous, like a zeolite support, reducing the crystallite size increases the surface area-to-volume ratio, which includes the outside of the particles and inside the pores. A larger exterior surface area may enhance interaction between the support and the promoter. For IF1, the crystallite size of the support and surface area were respectively increased and reduced to 13.1 nm and 410 m²/g compared to the pristine catalyst (12.6 nm and 440 m²/g). As used herein “pristine” refers to a catalyst that has not been mechanochemically treated. For IF2, both the crystallite size and surface area were decreased to 10.5 nm and 428 m²/g, respectively.

In at least one embodiment, mechanochemically processing the support includes milling the input material. In some embodiments, the milling is planetary ball milling. The planetary ball milling may be conducted under wet conditions, using zirconia jars and zirconia balls (weight of 3 g) and DI water for the wet medium. The input material may be milled at 300 RPM for 4 hours, while maintaining a ball-to-powder ratio and water-to-powder ratio of 12:1. The produced slurry may be dried overnight.

At Step 204, a loading material is impregnated/loaded onto the processed input material. In at least one embodiment, the loading material is one or more aqueous solutions. In some embodiments, the loading material is the promoter and the one or more metals. As discussed above, the aqueous solution of the promoter La₂O₃ may be La(NO₃)₃ and the amount of promoter solution may be sufficient to produce a catalyst comprising 10La₂O₃ (10 wt % La₂O₃). The one or more metals may be nickel (Ni) or nickel-copper (NiCu). The one or more metals may be in an aqueous solution. The loading material may include an aqueous solution of Ni and an aqueous solution of Cu. For example, Ni may be loaded onto the support as a solution of Ni(NO₃)₂, and Cu may be loaded onto the support as a solution of Cu(NO₃)₂. In some embodiments, the amount of Ni and Cu solutions may be sufficient to produce a catalyst comprising 10Ni5Cu (10 wt % Ni and 5 wt % Cu). In at least one embodiment, when the loading material includes the promoter, the promoter enhances dispersion of the metal onto the support. Depending on the heat treatment conditions, NiCu alloy formation may emerge.

An incipient wetness impregnation method may be utilized for Step 204. Loading the promoter and the one or more metals on the support includes two-step impregnation method using La(NO₃)₃·6H₂O, Cu(NO₃)₂·3H₂O, and Ni(NO₃)₂·6H₂O nitrate precursors In one example, the two-step impregnation method is conducted at 400 RPM for 4 hours at 125° C. The mixture may be stirred during the two-step impregnation method.

In at least one embodiment, Step 204 further includes drying and calcination of the loaded support. In at least one embodiment, drying and calcination forms La₂O₃, NiO, and CuO on the support. In some embodiments, a method for drying and calcination of the loaded support includes treatment at 500° C. under air environment.

In at least one embodiment, the catalyst produced by method 200 is a NiCu/La-zeolite catalyst. The NiCu/La-zeolite catalyst may comprise 10 wt % Ni, 5 wt % Cu, 10 wt % La₂O₃, 75 wt % zeolite. In some embodiments, the formula of the NiCu/La-zeolite catalyst is 10Ni5Cu/10La₂O₃/zeolite (10 wt % Ni, 5 wt % Cu, 10 wt % La₂O₃, 75 wt % zeolite support). For example, the NiCu/La-zeolite catalyst may be a 10Ni5Cu/10La₂O₃/zeolite catalyst, a 10Ni5Cu/10La₂O₃/Beta catalyst, or a 10Ni5Cu/10La₂O₃/H-Beta catalyst. A 10Ni5Cu/10La₂O₃/Beta catalyst may be characterized by a crystallite size (D_{Beta}) of about 13-11 nm; an average metal particle size (d_{M}) of about 4-5 nm; a metal (Ni+NiCu) dispersion (D_{M}) of about 21-25%; a Ni crystallite size (D_{Ni}) of about 14-16 nm; a total surface area of about 400-450 m²/g; a total basic site of about 0.120-0.225 mmol/g; and a total acid site of about 1-1.2 mmol/g.

As noted above, method 200 may be utilized to generate different modified catalyst interfaces. For example, a first interface of the catalyst may be generated when the promoter is part of the loading material, while a second interface of the catalyst may be generated when the promoter is part of the input material. A first interface manufactured by method 200 may be identified herein by the affix IF1, e.g., IF1 interface, _IF1 or (IF1) while a second interface of the catalyst may be identified herein by the affix IF2, e.g., IF2 interface, IF2 or (IF2). Some interface catalysts that may be generated by method 200 include NiCu/La-zeolite_IF1, NiCu/La-zeolite_IF2, NiCu/La-H-Beta IF1, NiCu/La-H-Beta_IF2, 10Ni5Cu/10La₂O₃/H-Beta IF1, and 10Ni5Cu/10La₂O₃;/H-Beta_IF2. Table 1 compares the characteristics of the 10Ni5Cu/10La₂O₃/H-Beta_IF1 and 10Ni5Cu/10La₂O₃/H-Beta_IF2 catalysts produced by method 200. Both of the IF1 and IF2 10Ni5Cu/10La₂O₃/H-Beta catalysts are characterized by Ni in its metallic form, and Cu in its metallic form.

TABLE 1
Characteristics of 10Ni5Cu/10La₂O₃/
H-Beta_IF1 and 10Ni5Cu/10La₂O₃/H-Beta_IF2

| | IF1 | IF2 |
|---|---|---|
| crystallite size (D_{Beta}_{,} nm) | 13.13 | 10.52 |
| average metal particle size (d_{M}, nm) | 4.1 | 4.4 |
| metal (Ni + NiCu) dispersion (D_{M}, %) | 24.7 | 21.1 |
| Ni crystallite size (D_{Ni}_{,} nm) | 14.49 | 15.35 |
| Total Surface Area (m²/g) | 410 | 428 |
| Total Basic Sites (mmol/g) | 0.212 | 0.133 |
| Total Acid Sites (mmol/g) | 1.131 | 1.091 |

The first interface of the 10Ni5Cu/10La₂O₃/H-Beta catalyst may be described as having a crystallite size (D_{Beta}) of about 13 nm; an average metal particle size (d_{M}) of about 4 nm; a metal (Ni+NiCu) dispersion (D_{M}) is 24-25%; a Ni crystallite size (D_{Ni}) of 14-15 nm; a total surface area of 400-420 m²/g; a total basic site of about 0.2 mmol/g; and a total acid site of about 1 mmol/g.

The second interface of the 10Ni5Cu/10La₂O₃/H-Beta catalyst may be described as having a crystallite size (D_{Beta}) of 10-11 nm; an average metal particle size (d_{M}) of 4-5 om; a metal (Ni+NiCu) dispersion (D_{M}) of about 21%; a Ni crystallite size (D_{Ni}) of about 15 nm; a total surface area of 425-430 m²/g; a total basic site of about 0.1 mmol/g; and a total acid site of about 1 mmol/g.

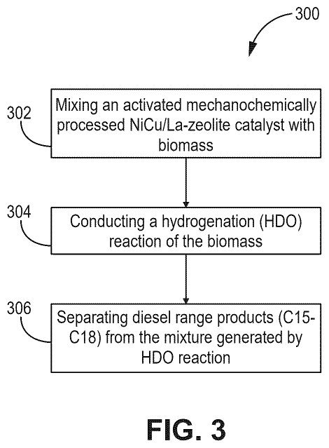

In at least one embodiment, the mechanochemically treated NiCu/La-zeolite catalyst is utilized to produce biodiesel products (C₁₅-C₁₈) from biomass via a HDO reaction. FIG. 3 is a flowchart of a method 300 to produce biodiesel products from biomass utilizing a NiCu/La-zeolite catalyst produced by method 200 (IF1, IF2). Briefly, method 300 includes mixing an activated NiCu/La-zeolite catalyst with biomass at Step 302, conducting a HDO reaction of the biomass mixture at Step 304; and separating diesel range products (paraffins, C₁₅-C₁₈) from the mixture generated by the HDO reaction at Step 306.

At Step 302, an activated mechanochemically processed NiCu/La-zeolite catalyst is mixed with biomass. The catalyst may be NiCu/La-zeolite_IF1, NiCu/La-zeolite_IF2, NiCu/La-H-Beta_IF1, NiCu/La-H-Beta_IF2, 10Ni5Cu/10La₂O₃/H-Beta_IF1, or 10Ni5Cu/10La₂O₃/H-Beta_IF2. The catalyst may be activated by a reduction method. Where the catalyst has been loaded with Ni and Cu, the reduction method may produce NiCu alloy nanoparticles on the support. A NiCu alloy active phase on the catalyst surface may promote adsorption and activation of the reactant molecules, resulting in high catalytic hydrogenation. For example, the NiCu alloy may enhance H₂ dissociation and H-spillover onto La₂O₃ during HDO. In at least one embodiment, the reduction method includes heating the catalyst at 300° C. for 2 h, under H₂ flow of 50 cc/min. The ratio of the catalyst to bio-feed may be 0.25.

At Step 304, a HDO reaction of the biomass mixture is conducted. The HDO reaction is conducted at a reaction temperature, a reaction pressure, and for a reaction time. The reaction temperature may be about 200-300° C., about 220-280° C., about 240-260° C., about 250° C., or at least 250° C. The reaction pressure may be about 30-65 bar, about 30 bar, about 50 bar, or about 65 bar. The reaction time may be about 1-3 hours, about 1 hour, about 2 hours, or about 3 hours. In at least one embodiment, the HDO reaction is conducted at a reaction temperature of 250° C., a reaction pressure of 50 bar H₂, and a reaction time of 1 h. For the bimetallic NiCu/La-zeolite catalyst, the Ni is configured for hydrodeoxygenation, the Cu is configured to suppress over-cracking, and the La₂O₃ is configured to mitigate coke formation and/or support dealumination resistance in the zeolite. Catalysts with a H-Beta support may include acid sites which catalyze isomerization of paraffins (C₁₅-C18) and/or aid in the dehydration/decarboxylation of free acids.

At Step 306, diesel range products (C₁₅-C₁₈) are separated from the mixture generated by the HDO reaction. Techniques that may be utilized at Step 306 include separation techniques and/or fractionation. For example, separation techniques may be utilized to separate light gasses from the mixture, remove water, and/or remove light ends. Fractionation may be utilized to separate hydrocarbons produced by the HDO reaction. Distillation may be utilized to obtain diesel range products (C₁₅-C₁₈).

### Experimental Evaluation

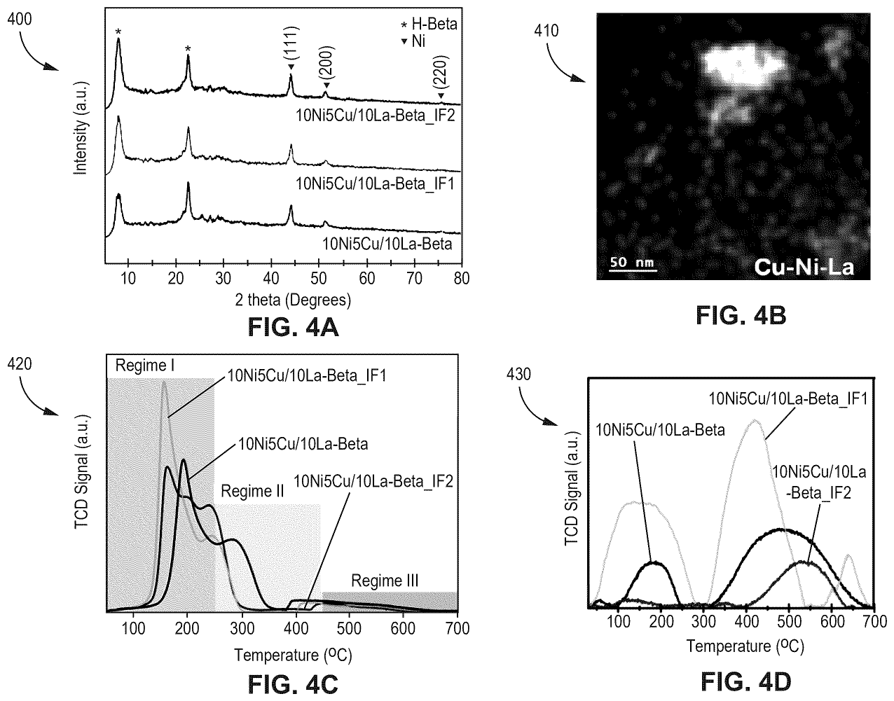

Experiments were conducted to characterize catalysts generated by method 200. FIG. 4A is a graph 400 of X-ray diffraction (XRD patterns of 10Ni5Cu/10La₂O₃/H-Beta generated without mechanochemical processing; 10Ni5Cu/10La₂O₃/H-Beta_IF1, and 10Ni5Cu/10La₂O₃/H-Beta_IF2. X-ray diffraction (XRD) provides insights on crystal structure and size. Before obtaining the X-ray diffraction (XRD) patterns, calcined catalysts were obtained by reducing the catalysts (heating the catalysts at 500° C. with a 10 vol % H₂/Ar gas at a rate of 30° C./min for 2 h). When the catalysts are reduced, typically the Ni⁺² reduces to Ni⁰ and Cu⁺ forms Cu⁰. Peaks corresponding to the NiO phase in the reduced catalysts are absent, meaning NiO particles were completely reduced to active Ni metal. The peaks at 2θ of 44.4°, 51.8°, and 76.2° may be attributed to Ni planes (111), (200), and (220), respectively. One of the peaks attributed to La₂O₃, peak at 28.13°, is barely visible which indicates that the promoter is well dispersed over the support and also happens to overlap with zeolite H-Beta peaks. The addition of Cu did not induce a segregated crystal structure, which suggests that the Cu may be well dispersed in the catalyst. Another possibility is that both Cu and Ni possess an FCC crystalline structure which could make it difficult to distinguish the 5% loaded Cu due to the high solubility onto the Ni phase.

The average crystallite size of zeolite H-Beta and Ni was calculated using the Scherrer equation. The crystallite size (D_{Beta}) of the H-Beta phase was 12.08 nm. In comparison, the IF1 interface produced by method 200 had a slightly larger crystallite size (13.13 nm) while the IF2 interface had a smaller crystallite size (10.52 nm). The increase of zeolite H-Beta size for the 10Ni5Cu/10La₂O₃/H-Beta_IF1 catalyst suggests recrystallization. The Ni crystallite size (D_{Ni}) of the catalysts with IF1 and IF2 interfaces were 14.49 and 15.35 nm respectively.

FIG. 4B is an image 410 of Red-Green-Blue (RGB) mapping analysis of 10Ni5Cu/10La₂O₃/H-Beta_IF1. RGB mapping represents the elemental composition of the catalysts, which is obtained by combining High-angle Annular Dark-field Scanning Transmission Electron Microscopy (HAADF-STEM) and Energy Dispersive X-ray Spectroscopy (EDS). The image displays the Ni (Green) and Cu (Red) agglomerated crystallized particles along with the very well-dispersed La (Blue) on the support. The yellow color seen in the region of interest attests to the possible chemical mixing (bonds forming) and alloy formation between Ni and Cu indicated by the red and green colors overlapping.

FIG. 4C is a graph 420 illustrating the results of H₂ temperature-programmed reduction (H₂-TPR) studies. These studies were conducted to assess the reducibility and metal-support interaction of 10Ni5Cu/10La₂O₃/H-Beta generated without mechanochemical processing, 10Ni5Cu/10La₂O₃/H-Beta_IF1, and 10Ni5Cu/10La₂O₃/H-Beta_IF2. The graph 420 reflects that the profiles can be categorized into different regimes, where Regime I is within temperatures of 50 to 250° C., Regime II is 250 to 350° C., and Regime III is 350 to 600° C. The reduction of bulk NiO typically has a single reduction peak around 300° C. leaning towards lower reduction temperatures. Ni loaded on silicate-based supports involves three main reduction peaks. Regime I is related to the partial reduction of NiO. Regime II is related to the reduction of large subsurface NiO crystallites that are weakly interacting with the support. Regime III, assigned to high temperature peaks, is related to small Ni²⁺ species which are strongly interacting with the support, thus more difficult to reduce. Ni²⁺ is reduced to Ni⁰ without any intermediate oxide. Graph 420 also shows that the profiles for 10Ni5Cu/10La₂O₃/H-Beta(IF1) and 10Ni5Cu/10La₂O₃/H-Beta(IF2) increase in intensity and shift towards lower reduction temperature compared to 10Ni5Cu/10La₂O₃/H-Beta generated without mechanochemical processing. This difference may be linked to the mechanochemical treatment enhancing the dispersion of Ni/Cu on the support. This could be a sign of interfacial charge distribution which facilitates the reduction of Ni/Cu to a metallic state (formation of active sites on the support).

FIG. 4D is a graph 430 illustrating the results of H₂ temperature-programmed desorption (H₂-TPD) experiments performed to assess the hydrogen chemisorption onto the surface exposed metal. Peaks below 350° C. can be assigned to the H₂ desorbed from the active (metal) sites while peaks positioned above 350° C. originate from H₂ spillover phenomenon and/or the reoxidation of Ni caused by water on the sample from reduction. Total metal (Ni and NiCu) dispersion (D_{M}, %) and average metal particle size (d_{M}, nm) of the catalysts may be estimated based on the amount of desorbed H₂ (peaks below 350° C.). The metal particle size (d_{M}, nm) of 10Ni5Cu/10La₂O₃/H-Beta, 10Ni5Cu/10La₂O₃/H-Beta(IF1), and 10Ni5Cu/10La₂O₃/H-Beta(IF2) was determined to be 4.3 nm, 4.1 nm, and 4.7 nm, respectively. All of the bimetallic catalysts showed an increase in D_{M}(%) due to the smaller particle sizes (competitive growth of the two metals). Mechanochemical treatment further increases the D_{M}(%) of the catalyst with IF1 displaying a D_{M}(%) of 24.7% and IF2 displaying a D_{M}(%) of 21.1%.

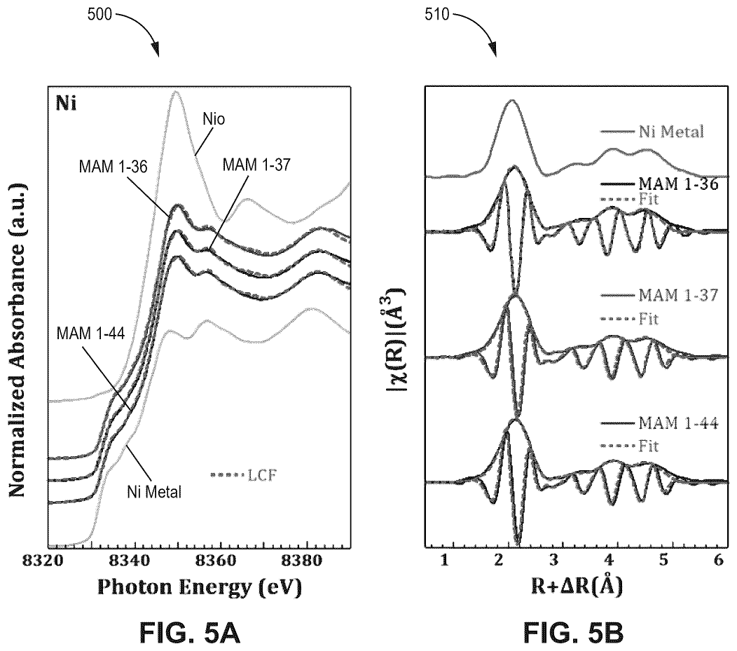

The local structure and coordination environment of the catalysts were investigated using synchrotron-based X-ray Absorption Fine Structure (XAFS) spectroscopy to obtain detailed insights into coordination numbers and interatomic distances. FIG. 5A provides a graph 500 of linear combination fitting (LCF) of the XANES spectra at the Ni K-edge (8333 eV), recorded for the 10Ni/10La-H-Beta (MAM 1-36), 10Ni5Cu/10La-H-Beta (MAM 1-37), and 10Ni5Cu/10La-H-Beta_IF1 (MAM 1-44) catalysts. In comparison to the Ni foil reference, the results indicate that Ni is present in the metallic state across all catalysts. FIG. 5B provides a graph 510 of an Extended XAFS Fourier Transform fitting of both the magnitude and real part for these samples. The observed peaks in the radial distribution are attributed to contributions from individual coordination shells surrounding the metallic atom. Consistent with the XANES findings, only Ni—Ni bonding contributions are detected within all coordination shells, with corresponding interatomic distances reported in Table 2.

TABLE 2
EXAFS derived structural parameters around the Ni atom.

| Sample | Bond | N (atom) | R (Å) | σ² (Å²) | ΔE (eV) |
|---|---|---|---|---|---|
| MAM | Ni—Ni | 9.4 ± 0.4 | 2.48 ± 0.002 | 0.007(03) | −4.5 ± 0.4 |
| 1-36 | Ni—Ni | 8.0 ± 2.7 | 3.54 ± 0.008 | 0.010(3) | 2.3 ± 0.2 |
| | Ni—Ni | 12.7 ± 2.4 | 4.31 ± 0.010 | 0.007(1) | −5.6 ± 1.5 |
| | Ni—Ni | 20.2 ± 3.8 | 4.85 ± 0.003 | 0.007(1) | 2.3 ± 0.2 |
| MAM | Ni—Ni | 9.8 ± 0.4 | 2.50 ± 0.002 | 0.008(03) | −3.9 ± 0.4 |
| 1-37 | Ni—Ni | 11.1 ± 4.1 | 3.57 ± 0.009 | 0.010(3) | 3.0 ± 0.1 |
| | Ni—Ni | 12.8 ± 2.7 | 4.34 ± 0.012 | 0.008(1) | −5.7 ± 1.5 |
| | Ni—Ni | 23.2 ± 4.5 | 4.89 ± 0.005 | 0.009(2) | 3.0 ± 0.4 |
| MAM | Ni—Ni | 10.0 ± 0.6 | 2.50 ± 0.002 | 0.008(05) | −3.5 ± .05 |
| 1-44 | Ni—Ni | 9.4 ± 4.7 | 3.57 ± 0.013 | 0.011(4) | 3.0 ± 0.5 |
| | Ni—Ni | 13.1 ± 2.9 | 4.34 ± 0.011 | 0.008(2) | −5.9 ± 1.4 |
| | Ni—Ni | 24.2 ± 5.7 | 4.90 ± 0.004 | 0.009(03) | 3.0 ± 0.1 |
| Ni | Ni—Ni | 12 | 2.339 | | |
| Metal* | Ni—Ni | 8 | 3.350 | | |
| | Ni—Ni | 24 | 4.325 | | |
| | Ni—Ni | 12 | 4.779 | | |

*calculated model

Having Ni primarily in the metallic state may enhance activity of the catalyst, as the presence of more active Ni⁰ sites facilitates H₂ dissociation and promotes the removal of oxygen from the oxygenated molecules in the form of water via the hydrodeoxygenation (HDO) pathway.

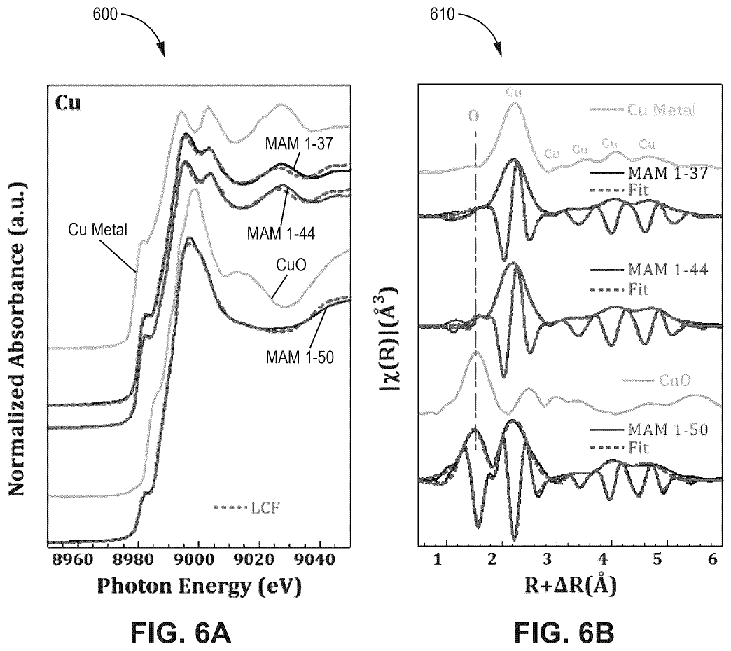

FIG. 6A is a graph 600 illustrating the results of X-ray absorption near edge structure (XANES) analysis at the Cu K-edge conducted to investigate the oxidation state of copper in the catalysts. The spectra of 10Ni5Cu/10La-H-Beta (MAM 1-37) and 10Ni5Cu/10La-H-Beta_IF1 (MAM 1-44) closely match that of the Cu foil reference, indicating that copper is present primarily in its metallic form. In contrast, the spectrum of 5Cu/10La-H-Beta (MAM 1-50) shows feature consistent with both metallic copper and copper oxide (CuO), suggesting the presence of copper in two different oxidation states.

FIG. 6B is a graph 610 illustrating the results of extended X-ray absorption fine structure (EXAFS) analysis and the derived structural parameters (Table 3) which provide further insights into the local structure around copper atoms. For both 10Ni5Cu/10La-H-Beta (MAM 1-37) and 10Ni5Cu/10La-H-Beta_IF1 (MAM 1-44), the results indicate that copper atoms are surrounded only by other copper atoms, supporting the conclusion that copper is in a metallic state. In the case of 5Cu/10La-H-Beta (MAM 1-50), the data show a clear Cu—O interaction in the first coordination shell, along with Cu—Cu contributions at longer distances. This confirms the mixed presence of both oxidized and metallic copper species in the material.

TABLE 2
EXAFS derived structural parameters around the Cu atom.

| Sample | Bond | N (atom) | R (Å) | σ² (Å²) | ΔE (eV) |
|---|---|---|---|---|---|
| MAM | Cu—O | 0.9 ± 0.5 | 1.94 ± 0.02 | 0.006(06) | 1.5 ± 0.3 |
| 1-37 | Cu—Cu | 8.7 ± 0.7 | 2.51 ± 0.01 | 0.008(06) | 3.0 ± 0.7 |
| | Cu—Cu | 19.5 ± 1.5 | 3.56 ± 0.03 | 0.013(09) | 3.4 ± 2.4 |
| | Cu—Cu | 30.1 ± 1.3 | 4.35 ± 0.02 | 0.013(03) | 1.5 ± 1.6 |
| | Cu—Cu | 30.1 ± 0.9 | 5.15 ± 0.02 | 0.010(02) | −3.6 ± 1.7 |
| MAM | Cu—O | 0.2 ± 0.1 | 1.92 ± 0.01 | 0.004(3) | 4.2 ± 0.1 |
| 1-44 | Cu—Cu | 10.1 ± 0.6 | 2.51 ± 0.03 | 0.009(1) | 4.6 ± 0.6 |
| | Cu—Cu | 24.1 ± 1.4 | 3.82 ± 0.04 | 0.010(5) | −3.1 ± 1.5 |
| | Cu—Cu | 42.9 ± 1.4 | 4.38 ± 0.05 | 0.011(3) | 4.3 ± 1.1 |
| | Cu—Cu | 30.2 ± 0.8 | 5.16 ± 0.05 | 0.012(2) | −1.8 ± 1.2 |
| MAM | Cu—O | 6.4 ± 0.8 | 1.92 ± 0.02 | 0.004(03) | 3.0 ± 0.2 |
| 1-50 | Cu—Cu | 7.6 ± 1.5 | 2.55 ± 0.02 | 0.009(03) | 1.0 ± 0.3 |
| | Cu—Cu | 0.2 ± 1.0 | 3.62 ± 0.02 | 0.009(2) | 1.7 ± 3.3 |
| | Cu—Cu | 24.5 ± 2.4 | 4.40 ± 0.05 | 0.009(1) | −5.8 ± 1.1 |
| | Cu—Cu | 30.6 ± 2.9 | 4.97 ± 0.7 | 0.010(1) | 3.0 ± 0.6 |
| CuO* | Cu—O | 6 | 1.151 | — | |
| | Cu—Cu | 4 | 2.101 | — | |
| | Cu—Cu | 4 | 3.083 | — | |
| | Cu—Cu | 2 | 3.173 | — | |
| Cu | Cu—Cu | 12 | 2.456 | — | |
| Metal* | Cu—Cu | 6 | 3.510 | — | |
| | Cu—Cu | 24 | 4.321 | — | |
| | Cu—Cu | 12 | 5.105 | — | |

*calculated model

Having Cu primarily in the metallic state may enhance activity of the catalyst by promoting alloy formation or electronic interaction with Ni, which can improve the reducibility of both, Ni and Cu species, and thus having more exposed active sites. In the NiCu bimetallic system, Cu can contribute to coke suppression and may aid in tuning the reaction pathway toward efficient oxygen removal through the hydrodeoxygenation mechanism.

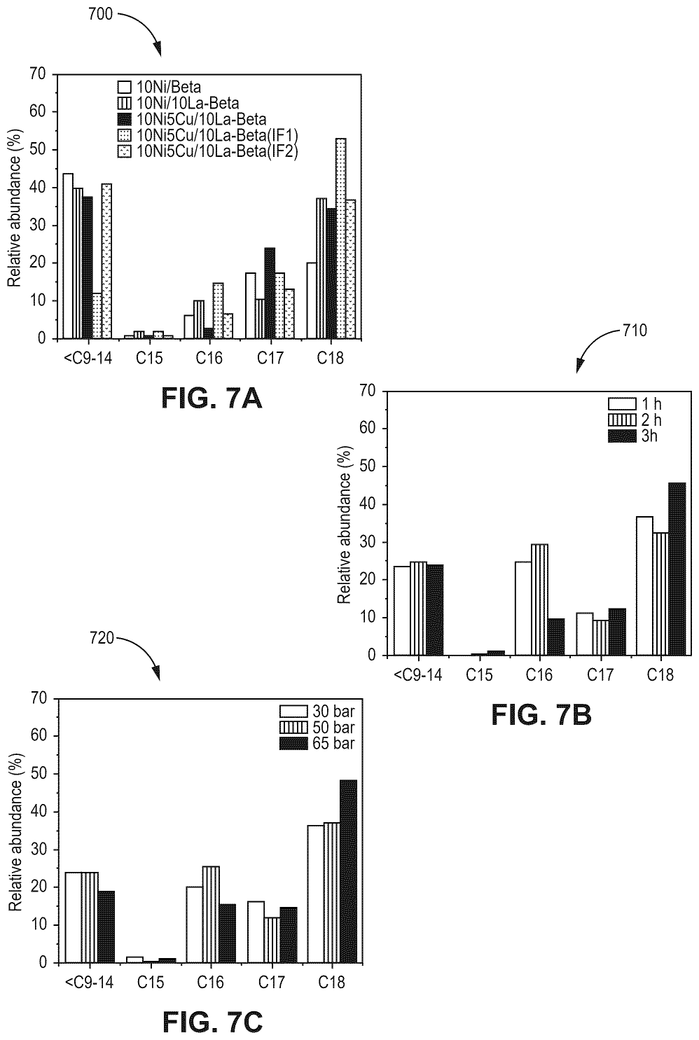

FIGS. 7A, 7B, and 7C illustrate results of HDO experiments conducted to evaluate the following catalysts: 10Ni/H-Beta (no mechanochemical treatment), 10Ni/10La-H-Beta (no mechanochemical treatment), 10Ni5Cu/10La-H-Beta (no mechanochemical treatment), 10Ni5Cu/10La-H-Beta (IF1), and 10Ni5Cu/10La-H-Beta (IF2). The HDO experiments were run in a lab-scale high-pressure stirred autoclave batch reactor (Parr, Model 4563). Catalytic studies of oleic acid (OA) hydrodeoxygenation (HDO) were conducted at 250° C., 50 bar H₂, for 1 h. All catalysts were reduced prior to that at 300° C. for 2 h, under H₂ flow 50 cc/min. FIG. 7A is a graph 700 illustrating the alkane carbon number distribution. The OA conversion over 10Ni/H-Beta, 10Ni/10La-H-Beta, 10Ni5Cu/10La-H-Beta, 10Ni5Cu/10La-H-Beta (IF1), and 10Ni5Cu/10La-H-Beta (IF2) catalysts was found to be 83, 98, 91, 93, and 91%, respectively. The promoted catalysts displayed better performance as the La₂O₃ addition appears to have enhanced the conversion toward alkane production (˜60%). The bimetallic catalysts also increased the alkane formation (˜75%) further compared to the formation of esters (˜15%). It is also evident that with each compositional addition there is greater selectivity towards biodiesel; namely the hydrocarbons in the C₁₅-C₁₈ range. IF2 promoted the production of biodiesel by 55% with respect to the pristine catalyst (41%). As for the mechanochemical treatment, IF2 has the highest alkane production of C₁₈ and the lowest conversion <C₉, showing very low alkane cracking (i.e. HDO prevails) given that the carbon number is mostly preserved. Bimetallic catalysts all showed a similar trend of better C₁₈ yield, compared to C₁₅-C₁₇ products. Additionally, TPR studies showed that the 10Ni5Cu/10La-H-Beta(IF1) catalyst was easily reduced at lower temperatures due to the higher dispersion induced by the applied mechanochemical treatment (D_{M},=24.7% from H₂-TPD studies). The formation of Cu⁰ and/or NiCu alloy active phase on the catalyst surface also promotes adsorption and activation of the reactant molecules, resulting in high catalytic hydrogenation.

FIG. 7B provides a graph 710 illustrating the effect of time, 1 h, 2 h, and 3 h, on 10Ni5Cu/10La-H-Beta (IF2). When run for 3 h, the IF2 catalyst showed an oleic acid conversion of 94%, with an alkane yield: 88.5% and C₁₅-C₁₈ selectivity: 70.74%. Increasing the time of reaction from 1 h to 3 h showed an improvement in the alkane yield and long-chained alkanes, while also increasing the n-alkane to iso-alkane production.

FIG. 7C provides a graph 720 illustrating the effect of pressure (30 bar, 50 bar, and 65 bar) at a constant reaction time of 1 h on 10Ni5Cu/10La-H-Beta (IF2). The increase of H₂ pressure may increase the n-alkane yield because of the enhancement of tandem hydrogenation rates and suppressed rate of decarbonylation reactions (DCO). H₂ pressure dependent testing showed that higher pressures resulted in higher C₁₈ alkane yields. Therefore, at 30 bar an increase in ester relative abundance was observed (not illustrated). Ester is an undesirable side product. For example, the formation of ester decreases the amount of desired diesel products and ester may complicate the separation of desired diesel products from the mixture generated by the HDO reaction.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method of manufacturing a catalyst, the method comprising:
mechanochemically processing an input material to generate a processed material, wherein the input material comprises:
a support, wherein the support is a zeolite, a Beta zeolite, or a H-Beta zeolite; and
loading the processed material with a loading material, wherein the loading material comprises nickel (Ni) or nickel-copper (NiCu);
wherein lanthanum oxide (La₂O₃) is a promoter for the catalyst, and
a first interface of a NiCu/La-zeolite catalyst is generated when the loading material further includes the promoter; and
a second interface of a NiCu/La-zeolite catalyst is generated when the input material further includes the promoter.

2. The method of claim 1, wherein the support comprises:
a SiO₂/Al₂O₃ mole ratio of 25; and
a surface area of 680 m²/g.

3. The method of claim 1, wherein mechanochemically processing the input material comprises milling the input material.

4. The method of claim 3, wherein planetary ball milling is utilized for milling the input material, the planetary ball milling utilizing zirconia jars and zirconia balls.

5. The method of claim 4, wherein:
the support is a powder; and
the planetary ball milling is conducted under wet conditions at 300 RPM for 4 hours and a ball-to-powder ratio and a water-to-powder ratio is 12:1.

6. The method of claim 1, wherein loading the processed material with a loading material comprises a two-step impregnation method that utilizes La(NO₃)₃·6H₂O, Cu(NO₃)₂·3H₂O, and Ni(NO₃)₂·6H₂O nitrate precursors and is conducted at 400 RPM for 4 hours at a temperature of about 125° C.

7. The method of claim 1, further comprising drying and calcination of the loaded support.

8. The method of claim 1, wherein the NiCu/La-zeolite catalyst is
a 10Ni5Cu/10La₂O₃/zeolite catalyst;
a 10Ni5Cu/10La₂O₃/Beta catalyst; or
a 10Ni5Cu/10La₂O₃/H-Beta catalyst.

9. The method of claim 8, wherein the NiCu/La-zeolite catalyst is characterized by one or more of:
a crystallite size (D_{Beta}) of about 13-11 nm;
an average metal particle size (d_{M}) of about 4-5 nm;
a metal (Ni+NiCu) dispersion (D_{M}) of about 21-25%;
a Ni crystallite size (D_{Ni}) of about 14-16 nm;
a total surface area of about 400-450 m²/g;
a total basic site of about 0.120-0.225 mmol/g; and
a total acid site of about 1-1.2 mmol/g.

10. A catalyst, wherein the catalyst is a 10Ni5Cu/10La₂O₃/H-Beta catalyst characterized by one or more of:
a crystallite size (D_{Beta}) of about 13-11 nm;
an average metal particle size (d_{M}) of about 4-5 nm;
a metal (Ni+NiCu) dispersion (D_{M}) of about 21-25%;
a Ni crystallite size (D_{Ni}) of about 14-16 nm;
a total surface area of about 400-450 m²/g;
a total basic site of about 0.120-0.225 mmol/g; and
a total acid site of about 1-1.2 mmol/g.

11. The catalyst of claim 10, wherein the 10Ni5Cu/10La₂O₃/H-Beta catalyst is a first interface of the 10Ni5Cu/10La₂O₃/H-Beta catalyst, wherein:
the crystallite size (D_{Beta}) is about 13 nm;
the average metal particle size (d_{M}) is about 4 nm;
the metal (Ni+NiCu) dispersion (D_{M}) is about 24-25%;
the Ni crystallite size (D_{Ni}) is about 14-15 nm;
the total surface area is about 400-420 m²/g;
the total basic site is about 0.2 mmol/g; and
the total acid site is about 1 mmol/g.

12. The catalyst of claim 10, wherein the 10Ni5Cu/10La₂O₃/H-Beta catalyst is a second interface of the 10Ni5Cu/10La₂O₃/H-Beta catalyst, wherein:
the crystallite size (D_{Beta}) is about 10-11 nm;
the average metal particle size (d_{M}) is about 4-5 nm;
the metal (Ni+NiCu) dispersion (D_{M}) is about 21%;
the Ni crystallite size (D_{Ni}) is about 15 nm;
the total surface area is about 425-430 m²/g;
the total basic site is about 0.1 mmol/g; and
the total acid site is about 1 mmol/g.

13. A method comprising:
mixing an activated mechanochemically processed NiCu/La-zeolite catalyst with biomass;
conducting a hydrogenation reaction (HDO) of the biomass; and
separating diesel range products from a mixture generated by the hydrogenation reaction.

14. The method of claim 13, wherein a ratio of the NiCu/La-zeolite catalyst to the biomass is 0.25.

15. The method of claim 13, wherein the activated mechanochemically processed NiCu/La-zeolite catalyst was generated by heating a mechanochemically processed NiCu/La-zeolite catalyst at 300° C. for 2 h, under a H₂ flow of 50 cc/min.

16. The method of claim 13, wherein parameters for the HDO reaction comprise:
a reaction temperature of about 200-300° C.;
a reaction pressure of about 30-65 bar; and
a reaction time of about 1-3 hours.

17. The method of claim 16, wherein the reaction temperature is about 250° C., the reaction pressure is about 50 bar H₂, and the reaction time is about 1 h.

18. The method of claim 13, wherein the NiCu/La-zeolite catalyst is a 10Ni₅Cu/10La₂O₃/H-Beta catalyst characterized by one or more of:
a crystallite size (D_{Beta}) of about 13-11 nm;
an average metal particle size (d_{M}) of about 4-5 nm;
a metal (Ni+NiCu) dispersion (D_{M}) of about 21-25%;
a Ni crystallite size (D_{Ni}) of about 14-16 nm;
a total surface area of about 400-450 m²/g;
a total basic site of about 0.120-0.225 mmol/g; and
a total acid site of about 1-1.2 mmol/g.

19. The method of claim 18, wherein the 10Ni5Cu/10La₂O₃/H-Beta catalyst is a first interface of the 10Ni5Cu/10La₂O₃/H-Beta catalyst, wherein:
the crystallite size (D_{Beta}) is about 13 nm;
the average metal particle size (d_{M}) is about 4 nm;
the metal (Ni+NiCu) dispersion (D_{M}) is about 24-25%;
the Ni crystallite size (D_{Ni}) is about 14-15 nm;
the total surface area is about 400-420 m²/g;
the total basic site is about 0.2 mmol/g; and
the total acid site is about 1 mmol/g.

20. The method of claim 18, wherein the 10Ni5Cu/10La₂O₃/H-Beta catalyst is a second interface of the 10Ni5Cu/10La₂O₃/H-Beta catalyst, wherein:
the crystallite size (D_{Beta}) is about 10-11 nm;
the average metal particle size (d_{M}) is about 4-5 nm;
the metal (Ni+NiCu) dispersion (D_{M}) is about 21%;
the Ni crystallite size (D_{Ni}) is about 15 nm;
the total surface area is about 425-430 m²/g;
the total basic site is about 0.1 mmol/g; and
the total acid site is about 1 mmol/g.
